(19) United States
(12) Patent Application Publication
(10) Pub. No.: US 2024/0168159 A1
(43) Pub. Date: May 23, 2024

(54) DISTANCE MEASURING DEVICE, DISTANCE MEASURING SYSTEM, AND DISTANCE MEASURING METHOD

(71) Applicant: SONY GROUP CORPORATION, TOKYO (JP)

(72) Inventor: YOSUKE KONNO, TOKYO (JP)

(21) Appl. No.: 18/548,973

(22) PCT Filed: Feb. 22, 2022
(86) PCT No.: PCT/JP2022/007145

§ 371 Date: Sep. 5, 2023

(30) Foreign Application Priority Data
Mar. 12, 2021 (JP) 2021-040207

(51) Int. Cl. G01S 17/36; G01S 7/48; G01S 7/486; G01S 17/86

(52) U.S. Cl. CPC G01S 17/36; G01S 7/4808; G01S 7/486; G01S 17/86

(57) ABSTRACT

A distance measuring device is provided that includes a first acquisition unit (232) that acquires a plurality of luminance images from a light receiving unit that receives light having a predetermined irradiation pattern reflected by a target object while sequentially shifting the light by a predetermined phase with reference to the irradiation pattern, a second acquisition unit (234) that acquires sensing data from a motion sensor that detects a position and an attitude of the light receiving unit, a correction unit (240) that corrects the luminance image on the basis of the position and the attitude obtained from the sensing data, and a calculation unit (260) that calculates a distance to the target object on the basis of the plurality of corrected luminance images.

### FIELD

The present disclosure relates to a distance measuring device, a distance measuring system, and a distance measuring method.

### BACKGROUND

In recent years, with the progress of semiconductor technology, miniaturization of a distance measuring device that measures a distance to an object has been advanced. Thus, for example, the distance measuring device can be mounted on a mobile terminal such as what is called a smartphone, which is a small information processing device having a communication function. Furthermore, as a distance measuring method by a distance measuring device, for example, an indirect time of flight (Indirect ToF) method is known. The Indirect ToF method is a method of irradiating a target object with light, receiving light returned after the irradiation light is reflected on a surface of the target object, detecting a time from when the light is emitted until when the reflected light is received as a phase difference, and calculating the distance to the target object on the basis of the phase difference.

In the Indirect ToF method, the light receiving sensor side receives the reflected light at light receiving timings with phases shifted by, for example, 0 degrees, 90 degrees, 180 degrees, and 270 degrees from the irradiation timing of the irradiation light. Then, in this method, the distance to the object is calculated using four luminance images detected in four different phases with respect to the irradiation timing of the irradiation light, and for example, a depth map (distance image) can be generated.

### CITATION LIST

### Patent Literature

Patent Literature 1: Japanese Translation of PCT International Application Publication No. 2020-513555

### SUMMARY

### Technical Problem

In the distance measurement by the Indirect ToF method, the four luminance images of the phase of 0 degrees, the phase of 90 degrees, the phase of 180 degrees, and the phase of 270 degrees are necessary, but the light receiving sensor may move while the luminance image of each phase is acquired. In such a case, since the composition capturing the target object that is stationary in the four luminance images changes, in a case where the depth map (distance image) is finally generated from these four luminance images, motion blur (subject blur) occurs in the depth map.

Accordingly, the present disclosure proposes a distance measuring device, a distance measuring system, and a distance measuring method capable of suppressing occurrence of motion blur.

### Solution to Problem

According to the present disclosure, there is provided a distance measuring device including: a first acquisition unit that acquires a plurality of luminance images from a light receiving unit that receives light having a predetermined irradiation pattern reflected by a target object while sequentially shifting the light by a predetermined phase with reference to the irradiation pattern; a second acquisition unit that acquires sensing data from a motion sensor that detects a position and an attitude of the light receiving unit; a correction unit that corrects the luminance images on a basis of the position and the attitude obtained from the sensing data; and a calculation unit that calculates a distance to the target object on a basis of the plurality of corrected luminance images.

Furthermore, according to the present disclosure, there is provided a distance measuring system including: an irradiation unit that irradiates a target object with light having a predetermined irradiation pattern; a light receiving unit that receives the light reflected by the target object while sequentially shifting the light by a predetermined phase with reference to the irradiation pattern; a motion sensor that detects a position and an attitude of the light receiving unit; a control unit that controls the irradiation unit; a correction unit that acquires a plurality of luminance images from the light receiving unit, acquires sensing data from the motion sensor, and corrects the luminance images on a basis of the position and the attitude obtained from the sensing data; and a calculation unit that calculates a distance to the target object on a basis of the plurality of corrected luminance images.

Furthermore, according to the present disclosure, there is provided a distance measuring method including: acquiring a plurality of luminance images from a light receiving unit that receives light having a predetermined irradiation pattern reflected by a target object while sequentially shifting the light by a predetermined phase with reference to the irradiation pattern; acquiring sensing data from a motion sensor that detects a position and an attitude of the light receiving unit; correcting the luminance images on a basis of the position and the attitude obtained from the sensing data; and calculating a distance to the target object on a basis of the plurality of corrected luminance images, by a processor.

### BRIEF DESCRIPTION OF DRAWINGS

FIG. 1 is an explanatory diagram (part 1) for describing a distance measurement principle of an Indirect ToF method.

FIG. 2 is an explanatory diagram (part 2) for describing a distance measurement principle of the Indirect ToF method.

FIG. 3 is an explanatory diagram for describing a conventional technique.

FIG. 4 is an explanatory diagram (part 1) for describing a first embodiment of the present disclosure.

FIG. 5 is an explanatory diagram (part 2) for describing the first embodiment of the present disclosure.

FIG. 6 is an explanatory diagram (part 3) for describing the first embodiment of the present disclosure.

FIG. 7 is an explanatory diagram (part 4) for describing the first embodiment of the present disclosure.

FIG. 8 is a block diagram illustrating an example of a configuration of a distance measuring device 10 according to the first embodiment of the present disclosure.

FIG. 9 is a block diagram illustrating an example of a configuration of a signal processing unit 230 according to the first embodiment of the present disclosure.

FIG. 10 is a flowchart illustrating an example of a distance measuring method according to the first embodiment of the present disclosure.

FIG. 11 is a schematic diagram illustrating an example of a structure of a 2-tap type pixel 212. FIG. 12 is an explanatory diagram for describing operation of the 2-tap type pixel 212 illustrated in FIG. 11.

FIG. 13 is an explanatory diagram (part 1) for describing a second embodiment of the present disclosure. FIG. 14 is an explanatory diagram (part 2) for describing the second embodiment of the present disclosure. FIG. 15 is an explanatory diagram (part 3) for describing the second embodiment of the present disclosure.

FIG. 16 is a block diagram illustrating an example of a configuration of a signal processing unit 230a according to the second embodiment of the present disclosure.

FIG. 17 is a flowchart illustrating an example of a distance measuring method according to the second embodiment of the present disclosure.

FIG. 18 is a hardware configuration diagram illustrating an example of a computer that implements functions of the signal processing unit 230.

FIG. 19 is a block diagram illustrating a configuration example of a smartphone 900 as an electronic device to which the distance measuring device 10 according to the embodiment of the present disclosure is applied.

FIG. 20 is a block diagram depicting an example of schematic configuration of a vehicle control system.

FIG. 21 is a diagram of assistance in explaining an example of installation positions of an outside-vehicle information detecting section and an imaging section.

### Description of Embodiments

Hereinafter, preferred embodiments of the present disclosure will be described in detail with reference to the accompanying drawings. Note that, in the present description and the drawings, components having substantially the same functional configuration are denoted by the same reference numerals, and redundant description is omitted. In addition, in the present description and the drawings, a plurality of components having substantially the same or similar functional configuration may be distinguished by attaching different alphabets after the same reference numeral. However, in a case where it is not particularly necessary to distinguish each of a plurality of components having substantially the same or similar functional configuration, only the same reference numeral is attached.

Note that the description will be given in the following order.
1. Background Leading to Creation of Embodiments of Present Disclosure
1.1 Principle of Distance Measurement by Indirect ToF Method
1.2 Background Leading to Creation
1.3 Overview of Embodiment of Present Disclosure
2. First Embodiment
2.1 Detailed Configuration of Distance Measuring Device 10
2.2 Detailed Configuration of Signal Processing Unit
2.3 Distance Measurement Method
3. Second Embodiment
3.1 2-Tap Sensor
3.2 Overview of Embodiment
3.3 Detailed Configuration of Signal Processing Unit 230a
3.4 Distance Measurement Method
4. Summary
5. Hardware Configuration
6. Application Example
6.1 Application Example to Smartphone
6.2 Application Example to Mobile Body
7. Supplement

### 1. Background Leading to Creation of Embodiments of Present Disclosure

First, before describing the embodiments of the present disclosure, the background leading to creation of the embodiments of the present disclosure by the present inventor will be described.

### 1.1 Principle of Distance Measurement by Indirect ToF Method

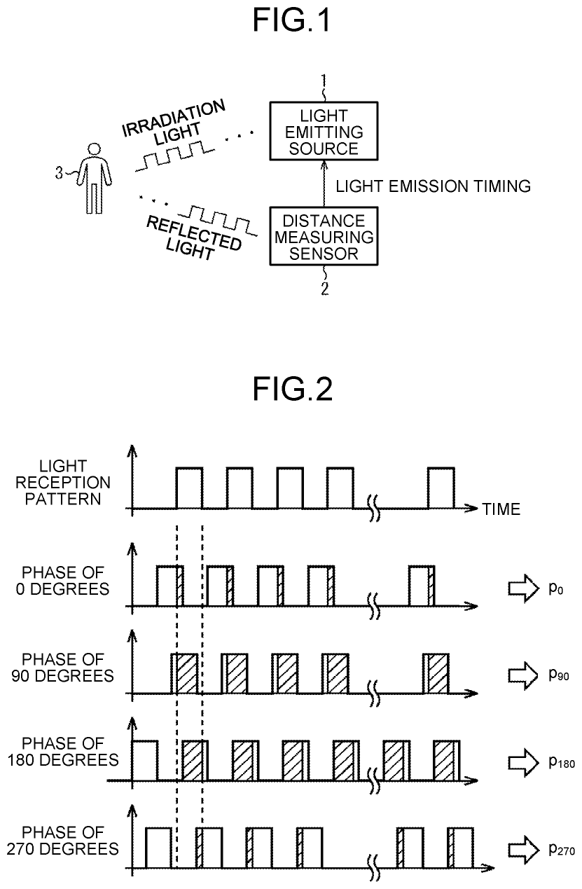

The present disclosure relates to a distance measuring device that performs distance measurement by an Indirect ToF method. Thus, first, the distance measurement principle of the general Indirect ToF method will be briefly described with reference to FIGS. 1 and 2.

FIGS. 1 and 2 are explanatory diagrams for describing a distance measurement principle of the Indirect ToF method. As illustrated in FIG. 1, a light emitting source 1 emits light modulated at a predetermined frequency (for example, 100 MHz or the like) as irradiation light. As the irradiation light, for example, infrared light is used. The light emission timing at which the light emitting source 1 emits the irradiation light is instructed from a distance measuring sensor 2, for example.

The irradiation light emitted from the light emitting source 1 to the subject is reflected by the surface of a predetermined object 3 as the subject, becomes reflected light, and enters the distance measuring sensor 2. The distance measuring sensor 2 detects the reflected light, detects the time from when the irradiation light is emitted until when the reflected light is received as a phase difference, and calculates the distance to the object on the basis of the phase difference.

A depth value d corresponding to the distance from the distance measuring sensor 2 to the predetermined object 3 as a subject can be calculated by the following Expression (1).

$$\\ \begin{matrix}d = \frac{1}{2} \cdot c \cdot Δ t & ( 1 )\end{matrix}$$

Δt in Expression (1) is a time until the irradiation light emitted from the light emitting source 1 is reflected by the object 3 and enters the distance measuring sensor 2, and c represents the speed of light.

As the irradiation light emitted from the light emitting source 1, as illustrated in the upper part of FIG. 2, pulsed light having a light emission pattern that repeatedly turns on and off at a predetermined modulation frequency f at a high speed is employed. One cycle T of the light emission pattern is 1/f. In the distance measuring sensor 2, the phase of the reflected light (light receiving pattern) is detected to be shifted depending on the time Δt to reach the distance measuring sensor 2 from the light emitting source 1. When the phase shift amount (phase difference) between the light emission pattern and the light reception pattern is ϕ, the time Δt can be calculated by the following Expression (2).

$$\\ \begin{matrix}Δ t = \frac{1}{f} \cdot \frac{φ}{2 π} & ( 2 )\end{matrix}$$

Therefore, the depth value d corresponding to the distance from the distance measuring sensor 2 to the object 3 can be calculated by the following Expression (3) from Expressions (1) and (2).

$$\\ \begin{matrix}d = \frac{c φ}{4 π f} & ( 3 )\end{matrix}$$

Next, an example of a method of calculating the above-described phase difference ϕ will be described.

Each pixel (light receiving pixel) of the pixel array included in the distance measuring sensor 2 repeats ON/OFF at a high speed, performs photoelectric conversion with incident light received during an ON period, and accumulates charges.

The distance measuring sensor 2 sequentially switches execution timings of ON/OFF of each pixel of the pixel array, accumulates charges at respective execution timings, and outputs a detection signal according to the accumulated charges.

There are four types of ON/OFF execution timings, for example, the phase of 0 degrees, the phase of 90 degrees, the phase of 180 degrees, and the phase of 270 degrees .

Specifically, the execution timing of the phase of 0 degrees is a timing at which the ON timing (light receiving timing) of each pixel of the pixel array is set to the phase of the pulsed light emitted from the light emitting source 1, that is, the same phase as the light emission pattern.

The execution timing of the phase of 90 degrees is a timing at which the ON timing (light receiving timing) of each pixel of the pixel array is delayed by 90 degrees from the pulse light (light emission pattern) emitted from the light emitting source 1.

The execution timing of the phase of 180 degrees is a timing at which the ON timing (light receiving timing) of each pixel of the pixel array is delayed by 180 degrees from the pulse light (light emission pattern) emitted from the light emitting source 1.

The execution timing of the phase of 270 degrees is a timing at which the ON timing (light receiving timing) of each pixel of the pixel array is delayed by 270 degrees from the pulse light (light emission pattern) emitted from the light emitting source 1.

For example, the distance measuring sensor 2 sequentially switches the light receiving timing in the order of the phase of 0 degrees, the phase of 90 degrees, the phase of 180 degrees, and the phase of 270 degrees, and acquires the luminance value (accumulated charge) of the reflected light at each light receiving timing. Note that, in the present description, a sequence of receiving (imaging) four reflected lights at the phase of 0 degrees, the phase of 90 degrees, the phase of 180 degrees, and the phase of 270 degrees is defined as one frame. Note that, in FIG. 2, at the light receiving timing (ON timing) of each phase, the timing at which the reflected light is incident is shaded.

As illustrated in FIG. 2, when the light receiving timing is set to the phase of 0 degrees, the phase of 90 degrees, the phase of 180 degrees, and the phase of 270 degrees, when the luminance values (accumulated charges) are set to p₀, p₉₀, p₁₈₀, and p₂₇₀, respectively, the phase difference ϕ can be calculated by the following Expression (4) using the luminance values p₀, p₉₀, p₁₈₀, and p₂₇₀.

$$\\ \begin{matrix}φ = arc tan \frac{{p}_{90} - {p}_{270}}{{p}_{0} - {p}_{180}} = arc tan ( \frac{Q}{I} ) & ( 4 )\end{matrix}$$

I=p₀−p₁₈₀ and Q=p₉₀−p₂₇₀ in Expression (4) represent the real part I and the imaginary part Q obtained by converting the phase of the modulated wave of the irradiation light onto the complex plane (IQ plane). The depth value d from the distance measuring sensor 2 to the object 3 can be calculated by inputting the phase difference ϕ calculated by Expression (4) to Expression (3) described above.

Furthermore, the intensity of light received by each pixel is called reliability conf, and can be calculated by the following Expression (5). This reliability conf corresponds to the amplitude A of the modulated wave of the irradiation light.

A=conf=\sqrt{I²+Q²}

In addition, the magnitude B of the ambient light included in the received reflected light can be estimated by the following Expression (6).

B=(p₀+p₉₀+p₁₈₀+p₂₇₀)−\sqrt{(p₀−p₁₈₀)²+(p₉₀−p₂₇₀)²} (6)

For example, in the configuration in which the distance measuring sensor 2 includes one charge storage unit in each pixel of the pixel array, as described above, the light receiving timing is sequentially switched to the phase of 0 degrees, the phase of 90 degrees, the phase of 180 degrees, and the phase of 270 degrees, and the detection signal according to the accumulated charge (luminance value p₀, luminance value p₉₀, luminance value p₁₈₀, and luminance value p₂₇₀) in each phase is generated, so that four detection signals (hereinafter, also referred to as a luminance image) can be obtained.

Then, the distance measuring sensor 2 calculates a depth value (depth) d which is a distance from the distance measuring sensor 2 to the object 3 on the basis of four luminance images (the luminance image includes a luminance value (luminance information) of each pixel of the pixel array and coordinate information corresponding to each pixel) supplied for each pixel of the pixel array. Then, the depth map (distance image) in which the depth value d is stored as the pixel value of each pixel and a reliability map in which the reliability conf is stored as the pixel value of each pixel are generated and output from the distance measuring sensor 2 to an external device.

### 1.2 Background Leading to Creation

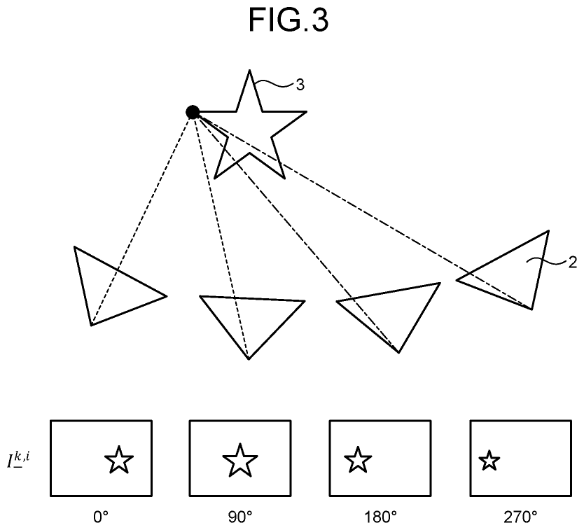

Next, the background leading to creation of the embodiment of the present disclosure by the present inventor will be described with reference to FIG. 3. FIG. 3 is an explanatory diagram for describing a conventional technique. Note that, here, a situation in which distance measurement to a stationary object (target object) 3 is performed will be described as an example.

As described above, as illustrated in the lower part of FIG. 3, the distance measuring sensor 2 that performs distance measurement by the Indirect ToF method needs four luminance images I₋^{k, i} of the phase of 0 degrees, the phase of 90 degrees, the phase of 180 degrees, and the phase of 270 degrees in order to perform distance measurement. As described above, on the principle that the four luminance images I₋^{k, i} have to be acquired for one distance measurement, as illustrated in the upper part of FIG. 3, the distance measuring sensor 2 may move while acquiring the luminance images I₋^{k, i} of each phase. In such a case, as illustrated in the lower part of FIG. 3, since the composition capturing the object (target object) 3 that is stationary changes in the four luminance images I₋^{k, i}, in a case where the depth map (distance image) is finally generated from the four luminance images I₋^{k, i}, motion blur (subject blur) occurs in the depth map. In particular, in a case where the distance of an object at a short distance is measured or in a case where the distance measuring sensor rotates, the appearance on the image greatly changes even in a motion in a minute time, and thus it is easily affected by the motion blur.

Then, for example, when motion blur occurs in the depth map, the depth value d is mixed in a depth discontinuous surface (for example, in a case where the object 3 is a desk, the region of a boundary line between the desk and the floor), and the position of the point in the region of the corresponding discontinuous surface is greatly disturbed when viewed as the depth map. Such a phenomenon causes significant accuracy degradation in applications using depth maps (for example, self-position estimation (simultaneous localization and mapping; SLAM), three-dimensional model generation, and the like).

Therefore, in view of such a situation, the present inventor has created embodiments of the present disclosure described below.

### 1.3 Outline of Embodiment of Present Disclosure

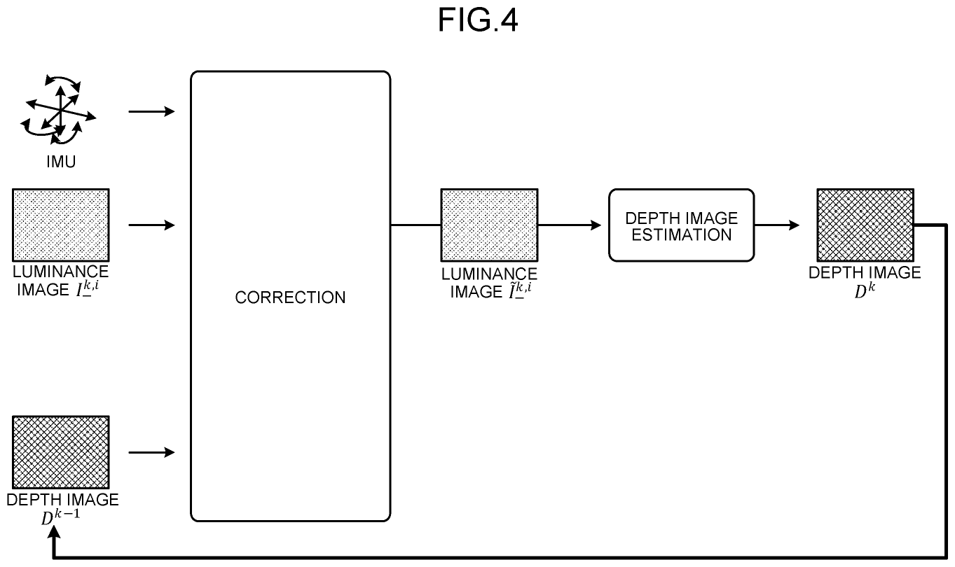

Next, an outline of a first embodiment of the present disclosure created by the present inventor will be described with reference to FIGS. 4 to 7. FIGS. 4 to 7 are explanatory diagrams for describing the first embodiment of the present disclosure.

In the embodiment of the present disclosure created by the present inventor, as illustrated in FIG. 4, the four luminance images I₋^{k, i} are corrected using sensing data from an inertial measurement unit (IMU) mounted on the distance measuring sensor 2 and the depth map (depth image) D^{k-1} one frame before. Then, depth image estimation is performed using luminance images I^{˜}₋^{k, i}after correction to acquire a depth image (depth map) D^{k}. That is, in the present embodiment, the occurrence of motion blur is suppressed by correcting the luminance images I₋^{k, i}.

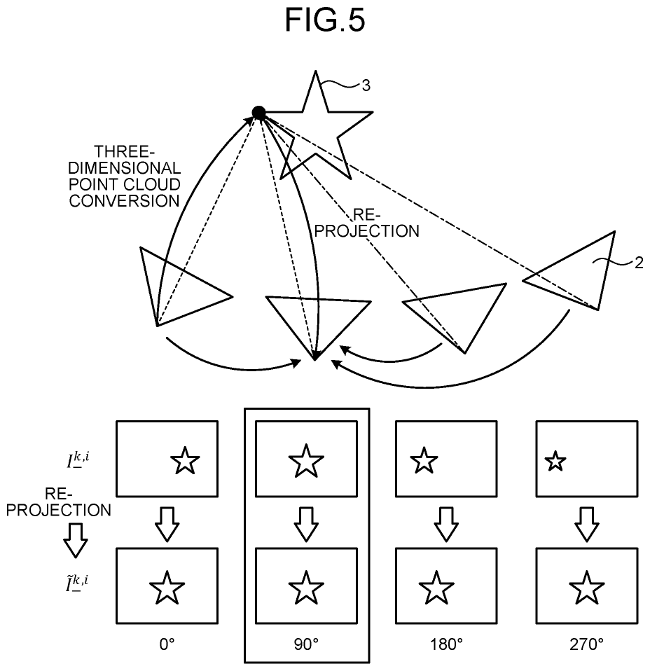

As described above, the distance measuring sensor 2 that performs distance measurement by the Indirect ToF method requires the four luminance images I₋^{k, i} with the phase of 0 degrees, the phase of 90 degrees, the phase of 180 degrees, and the phase of 270 degrees in order to perform distance measurement, but the distance measuring sensor 2 may move while acquiring the luminance images I₋^{k, i} of the respective phases. In such a case, as illustrated in the middle part of FIG. 5, the composition capturing the object (target object) 3 that is stationary changes in the four luminance images I₋^{k, i}.

Accordingly, in the present embodiment, it is set as one reference of the four luminance images I₋^{k, i} (in the example of FIG. 5, the phase of 90 degrees), and the remaining other luminance images I₋^{k, i} (in the example of FIG. 5, the phases are 0 degrees, 180 degrees, and 270 degrees) are corrected so as to be images from viewpoints corresponding to the position and attitude of the distance measuring sensor 2 when the luminance image I₋^{k, i} serving as the reference is obtained. Δt that time, in the present embodiment, each luminance image I₋^{k, i} including a three-dimensional point cloud is corrected using a relative position and a relative attitude of the distance measuring sensor 2 obtained from the sensing data from the IMU mounted on the distance measuring sensor 2 and the depth map (depth image) D^{k-1} one frame before, and luminance images I^{˜}₋^{k, i} illustrated in the lower part of FIG. 5 are obtained. That is, in the present embodiment, the occurrence of motion blur can be suppressed by correcting each luminance image I₋^{k, i} so that the viewpoints are the same .

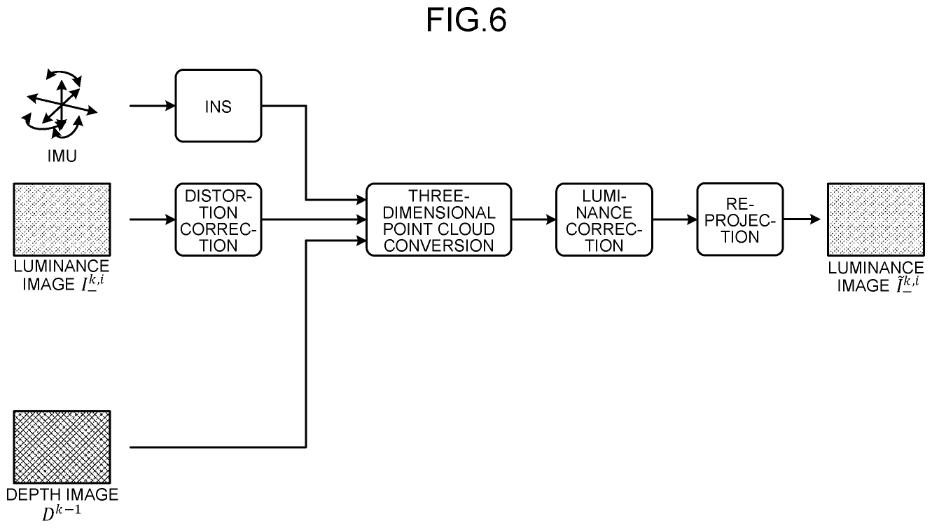

More specifically, in the present embodiment, as illustrated in FIG. 6, the relative position and the relative attitude of the distance measuring sensor 2 can be obtained on the basis of an inertial navigation system (INS (registered trademark)) using angular velocity and acceleration that are sensing data from the IMU mounted on the distance measuring sensor 2. Moreover, in the present embodiment, the correction is performed by converting the three-dimensional point cloud included in each of curvature-corrected luminance images I₋^{k, i} using the relative position and the relative attitude of the distance measuring sensor 2 obtained in this manner and the depth map (depth image) D^{k-1} one frame before.

Then, since the luminance value included in each luminance image I₋^{k, i} changes according to the distance to the object (target object) 3, in the present embodiment, as illustrated in FIG. 6, the luminance value is corrected depending on the distance changed by the previous correction (conversion). Moreover, in the present embodiment, as illustrated in FIG. 6, the luminance images I^{˜}₋^{k, i} can be obtained by reprojecting the three-dimensional point cloud subjected to the luminance correction onto the reference coordinates.

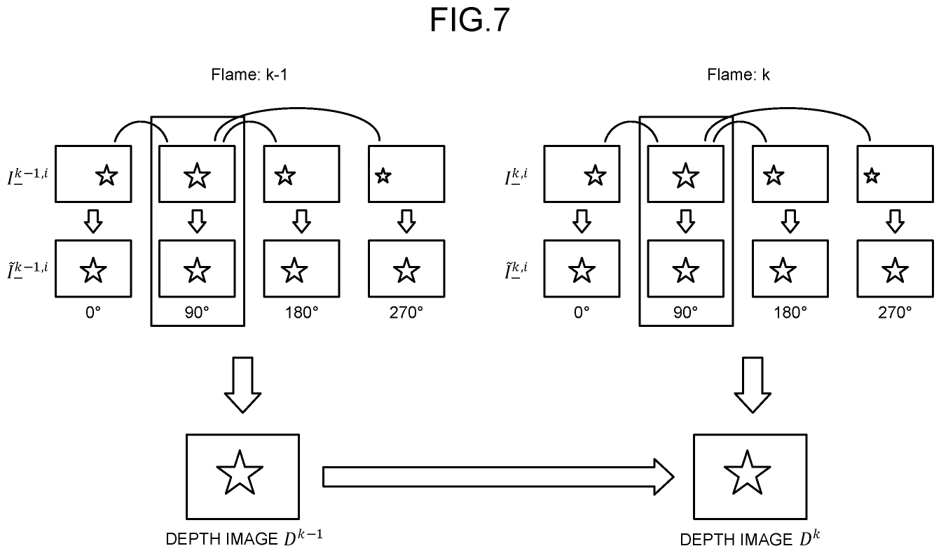

Moreover, the above-described correction (conversion of the three-dimensional point cloud) will be described with reference to FIG. 7. As illustrated on the right side of FIG. 7, in the present embodiment, one of a plurality of luminance images I₋^{k, i} acquired within one frame (on the right side of FIG. 7, the frame k) is set as reference data (in the example of FIG. 7, the phase of 90 degrees). Next, in the present embodiment, the plurality of other luminance images I₋^{k, i} is corrected on the basis of the relative position and the relative attitude of the distance measuring sensor 2 when the plurality of other luminance images I₋^{k, i} (in the example of FIG. 7, the phases of 0 degrees, 180 degrees, and 270 degrees) is acquired with respect to the position and the attitude (reference position) of the distance measuring sensor 2 when the reference data is acquired. Moreover, in the present embodiment, on the basis of the relative position and the relative attitude of the reference position of the target frame with respect to the reference position (in the example of FIG. 7, the phase of 90 degrees) of the previous frame (in FIG. 7, the frame k−1) of the target frame (in FIG. 7, the frame k), all the luminance images I₋^{k, i} of the target frame are corrected with reference to the depth map (distance image) D^{k-1} of the previous frame. Then, in the present embodiment, the depth map (depth image) D^{k} is acquired using the four luminance images I^{˜}₋^{k, i} obtained by the correction.

That is, in the present embodiment, since the depth map D^{k} is generated by correcting all the luminance images I₋^{k, i} so as to be luminance images from the viewpoint of the reference position, that is, from the same viewpoint, it is possible to remove the influence of movement of the distance measuring sensor 2 in the luminance image. As a result, according to the present embodiment, it is possible to suppress the occurrence of motion blur in the depth map D^{k}.

Hereinafter, details of such a first embodiment of the present disclosure will be sequentially described.

### 2. First Embodiment

### 2.1 Detailed Configuration of Distance Measuring Device 10

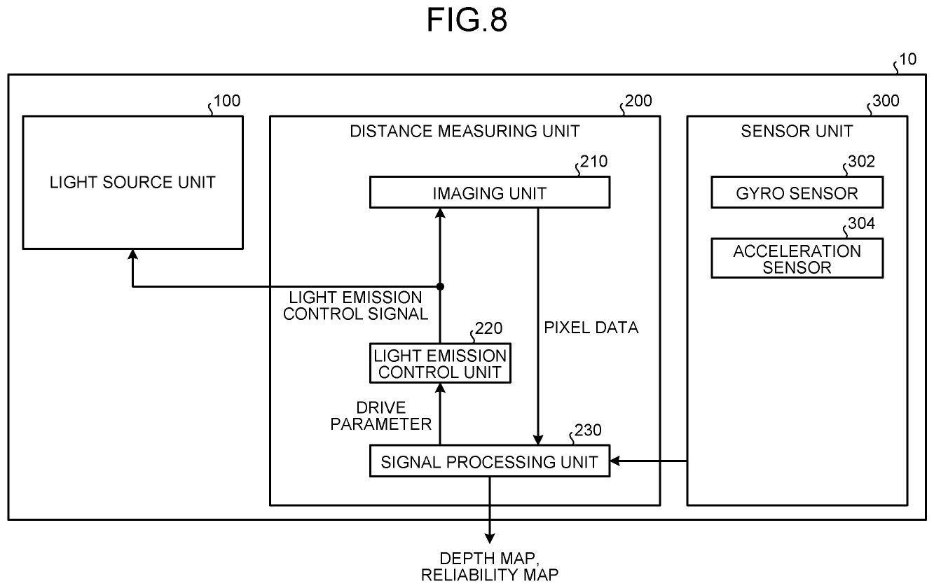

First, a detailed configuration of a distance measuring device 10 according to a first embodiment of the present disclosure will be described with reference to FIG. 8. FIG. 8 is a block diagram illustrating an example of a configuration of the distance measuring device 10 according to the present embodiment. The distance measuring device 10 is a device that performs distance measurement by the Indirect ToF method, and can generate and output the depth map as distance information to the object 3 by irradiating the object 3 (see FIG. 1) (target object) with light and receiving light (reflected light) that is the light (irradiation light) being reflected by the object 3. Specifically, as illustrated in FIG. 8, the distance measuring device 10 mainly includes a light source unit (irradiation unit) 100, a distance measuring unit 200, and a sensor unit (motion sensor) 300. Hereinafter, each functional block of the distance measuring device 10 will be sequentially described.

### Light Source Unit 100

The light source unit 100 includes, for example, a VCSEL array in which a plurality of vertical cavity surface emitting lasers (VCSELs) arranged in a planar manner, and can emit light while modulating the light at a timing according to a light emission control signal supplied from a light emission control unit 220 of the distance measuring unit 200 to be described later, and irradiate the object 3 with irradiation light (for example, infrared light). Note that, in the present embodiment, the light source unit 100 may include a plurality of light sources that irradiate the object 3 with two or more types of light having different wavelengths.

### Distance Measuring Unit 200

The distance measuring unit 200 can receive reflected light from the object 3, process a detection signal according to the amount of received reflected light, and control the light source unit 100 described above. Specifically, as illustrated in FIG. 8, the distance measuring unit 200 can mainly include an imaging unit (light receiving unit) 210, a light emission control unit 220, and a signal processing unit 230.

The imaging unit 210 is a pixel array configured by arranging a plurality of pixels in a matrix on a plane, and can receive reflected light from the object 3. Then, the imaging unit 210 can supply the pixel data of a luminance image formed by the detection signal according to the amount of received reflected light received to the signal processing unit 230 to be described later in units of pixels of the pixel array.

The light emission control unit 220 can control the light source unit 100 by generating the light emission control signal having a predetermined modulation frequency (for example, 100 MHz or the like) and supplying the signal to the light source unit 100 described above. Furthermore, the light emission control unit 220 can also supply the light emission control signal to the distance measuring unit 200 in order to drive the distance measuring unit 200 in accordance with the light emission timing in the light source unit 100. The light emission control signal is generated, for example, on the basis of the drive parameter supplied from the signal processing unit 230.

The signal processing unit 230 can calculate a true distance to the object 3 based on four luminance images (pixel data) captured by four types of light receiving patterns having different phases. Specifically, the signal processing unit 230 can calculate the depth value d, which is the distance from the distance measuring device 10 to the object 3, on the basis of the pixel data supplied from the imaging unit 210 for each pixel of the pixel array, and further generate the depth map in which the depth value d is stored as the pixel value of each pixel. In addition, the signal processing unit 230 may also generate a reliability map in which the reliability conf is stored as the pixel value of each pixel.

Moreover, in the present embodiment, the signal processing unit 230 can acquire information of the position and attitude of the distance measuring device 10 (specifically, the imaging unit 210) using sensing data obtained by the sensor unit 300 to be described later, and correct the luminance image on the basis of the acquired information. Note that details of the signal processing unit 230 will be described later.

### Sensor Unit 300

The sensor unit 300 is a motion sensor that detects the position and attitude of the distance measuring device 10 (specifically, the imaging unit 210), and includes, for example, a gyro sensor 302 and an acceleration sensor 304. Note that the sensor included in the sensor unit 300 is not limited to the inertial sensor (gyro sensor (angular velocity meter) and acceleration sensor (accelerometer)), and for example, may include a sensor such as a triaxial geomagnetic sensor or an atmospheric pressure sensor instead of or in addition to the inertial sensor. More specifically, the gyro sensor 302 is an inertial sensor that acquires an angular velocity as sensing data. Furthermore, the acceleration sensor 304 is an inertial sensor that acquires acceleration as sensing data.

### 2.2 Detailed Configuration of Signal Processing Unit 230

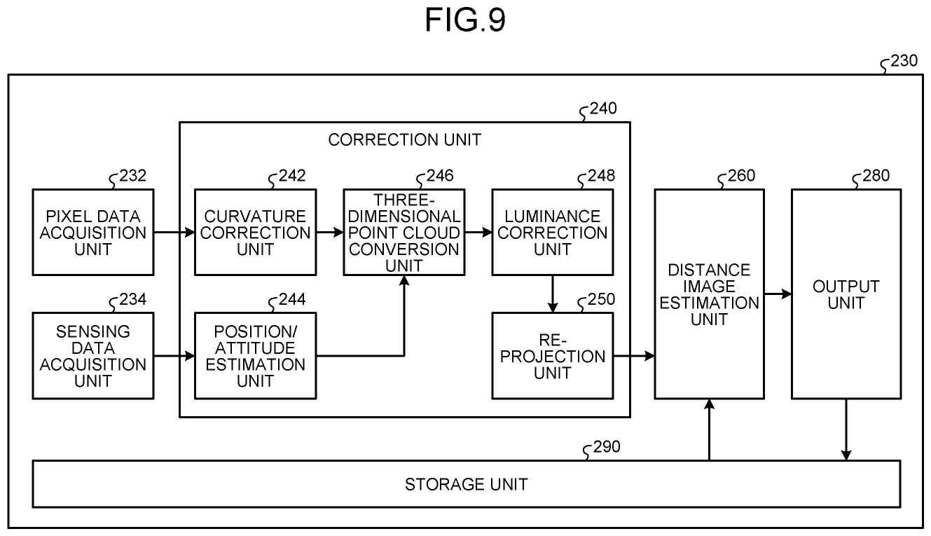

Next, a detailed configuration of the above-described signal processing unit 230 will be described with reference to FIG. 9. FIG. 9 is a block diagram illustrating an example of a configuration of the signal processing unit 230 according to the present embodiment. As illustrated in FIG. 9, the signal processing unit 230 mainly includes a pixel data acquisition unit (first acquisition unit) 232, a sensing data acquisition unit (second acquisition unit) 234, a correction unit 240, a distance image estimation unit (calculation unit) 260, an output unit 280, and a storage unit 290. Hereinafter, each functional block of the signal processing unit 230 will be sequentially described.

### Pixel Data Acquisition Unit 232

The pixel data acquisition unit 232 can acquire pixel data (luminance image) from the imaging unit (light receiving unit) 210 that receives light having a predetermined irradiation pattern reflected by the object (target object) 3 while sequentially shifting the light by a predetermined phase with reference to the irradiation pattern, and output the pixel data to the correction unit 240 described later.

### Sensing Data Acquisition Unit 234

The sensing data acquisition unit 234 can acquire sensing data from a sensor unit (motion sensor) 300 that detects the position and attitude of the imaging unit (light receiving unit) 210, and output the sensing data to the correction unit 240.

### Correction Unit 240

The correction unit 240 can correct the pixel data (luminance image) from the imaging unit (light receiving unit) 210 on the basis of the position and the attitude of the imaging unit (light receiving unit) 210 obtained from the sensing data from the sensor unit (motion sensor) 300. Specifically, as illustrated in FIG. 9, the correction unit 240 mainly includes a curvature correction unit (distortion correction unit) 242, a position/attitude estimation unit (estimation unit) 244, a three-dimensional point cloud conversion unit (conversion unit) 246, a luminance correction unit 248, and a reprojection unit 250. Hereinafter, each functional block of the correction unit 240 will be sequentially described.

The curvature correction unit 242 can correct distortion (for example, distortion or the like of an outer peripheral portion of the image) due to an optical system such as a lens in the pixel data (luminance image) acquired from the pixel data acquisition unit 232, and can output the corrected pixel data to the three-dimensional point cloud conversion unit 246 to be described later.

The position/attitude estimation unit 244 can estimate the relative position and the relative attitude of the imaging unit (light receiving unit) 210 when each piece of pixel data (luminance image) is obtained from the time-series acceleration and angular velocity data (sensing data) from the sensor unit (motion sensor) 30. Then, the position/attitude estimation unit 244 can output information of the estimated relative position and relative attitude of the imaging unit 210 to the three-dimensional point cloud conversion unit 246 to be described later. For example, the position/attitude estimation unit 244 can estimate the position/attitude on the basis of inertial navigation. In inertial navigation, a position can be calculated by integrating angular velocity and acceleration a plurality of times.

Specifically, in the inertial navigation, first, the angular velocity (an example of the sensing data) in a local coordinate system acquired by the gyro sensor 302 included in the sensor unit 300 is integrated to calculate the attitude of the sensor unit 300 (that is, the imaging unit 210) in a global coordinate system. Next, on the basis of the attitude of the sensor unit 300 in the global coordinate system, the acceleration (an example of the sensing data) of the sensor unit 300 in the local coordinate system (the coordinate system set in the sensor unit 300) acquired by the acceleration sensor 304 included in the sensor unit 300 is subjected to coordinate-system conversion into the acceleration of the sensor unit 300 (that is, the imaging unit 210) in the global coordinate system. Then, the velocity of the sensor unit 300 (that is, the imaging unit 210) in the global coordinate system is calculated by integrating the acceleration of the sensor unit 300 in the global coordinate system subjected to the coordinate system conversion. Next, the moving distance of the sensor unit 300 (that is, the imaging unit 210) is calculated by integrating the velocity of the sensor unit 300 in the global coordinate system. Here, by combining the moving distance of the sensor unit 300 (that is, the imaging unit 210) in the global coordinate system, relative position information of the sensor unit 300 (that is, the imaging unit 210) with the reference position as a starting point is obtained. In this manner, the relative attitude information and the relative position information of the sensor unit 300, that is, the imaging unit 210 can be obtained by estimation based on inertial navigation.

Note that, in the present embodiment, the position/attitude estimation unit 244 is not limited to performing the estimation as described above, and may perform the estimation using, for example, a model or the like obtained by machine learning.

As described above, the three-dimensional point cloud conversion unit 246 can set one of a plurality of pieces of pixel data (luminance image) acquired in one frame as the reference data (reference luminance image). Next, the three-dimensional point cloud conversion unit 246 can correct the plurality of pieces of other pixel data other than the reference data on the basis of the relative position and the relative attitude of the imaging unit 210 when the plurality of pieces of other pixel data (luminance images) is acquired with respect to the position and the attitude (reference position) of the imaging unit (light receiving unit) 210 when the reference data is acquired. Specifically, as described above, in the pixel data, the luminance value (luminance information) of each pixel and the coordinate information corresponding to each pixel are stored in association with each other. Therefore, in the present embodiment, the three-dimensional point cloud conversion unit 246 converts the coordinate information on the basis of the relative position and the relative attitude of the imaging unit 210, and converts the coordinate information such that all the pixel data of the same frame becomes the pixel data obtained at the position and the attitude (the reference position) of the imaging unit 210 when the reference data is acquired.

Moreover, in the present embodiment, the three-dimensional point cloud conversion unit 246 converts the coordinate information of all the pixel data of the target frame in the same manner as described above with reference to (feedback) the depth map (distance image) of the previous frame on the basis of the relative position and the relative attitude of the reference position of the target frame with respect to the reference position of the previous frame of the target frame. That is, the three-dimensional point cloud conversion unit 246 converts all the pixel data to be the pixel data from the viewpoint of the reference position where the reference data is acquired in the frame (for example, the first frame) serving as the reference.

In the present embodiment, by performing such processing, it is possible to obtain a higher quality depth map since the motion blur of the depth map to be finally output is reduced by correcting the deviation in the position and attitude of the imaging unit 210 when each piece of pixel data is acquired.

Then, the three-dimensional point cloud conversion unit 246 outputs each piece of corrected (converted) pixel data to the luminance correction unit 248 to be described later.

By the correction (conversion) by the three-dimensional point cloud conversion unit 246 (by the conversion of viewpoint), the distance between the imaging unit (light receiving unit) 210 and the object (target object) 3 changes. Specifically, by the correction by the three-dimensional point cloud conversion unit 246, the distance between the imaging unit 210 and the object 3 changes by moving from the position of the imaging unit 210 when the pixel data is acquired to the reference position where the reference data is acquired in the frame serving as the reference. Therefore, when the distance changes, the luminance captured by the imaging unit 210 also changes. Accordingly, in the present embodiment, the luminance correction unit 248 corrects the luminance value (luminance information) on the basis of the changed distance (displacement). For example, the luminance correction unit 248 can correct the luminance value using a mathematical expression in which the luminance value linearly changes depending on the distance. Note that the luminance correction unit 248 is not limited to correcting the luminance value using a predetermined mathematical expression, and for example, may perform correction using a model or the like obtained by machine learning.

In addition, in the present embodiment, since there is little possibility that the luminance value greatly changes due to the small distance, the processing in the luminance correction unit 248 may be omitted, but the higher quality depth map can be obtained by performing such processing.

Then, the luminance correction unit 248 outputs each piece of pixel data subjected to the luminance correction to the reprojection unit 250 to be described later.

The reprojection unit 250 can reproject each piece of the pixel data subjected to the luminance correction so as to be the same as the viewpoint of the reference position from which the reference data has been acquired, and output the reprojected pixel data to the distance image estimation unit 260 to be described later. For example, the reprojection unit 250 can cause each piece of the pixel data subjected to luminance correction to be projected on a plane.

### Distance Image Estimation Unit 260

The distance image estimation unit 260 can calculate the distance to the object (target object) 3 on the basis of the corrected pixel data (luminance image), and can generate the depth map, for example. Then, the distance image estimation unit 260 can output the calculation result and the depth map to the output unit 280 to be described later.

### Output Unit 280

The output unit 280 can output the output data (depth map, reliability map, and the like) from the distance image estimation unit 260 to an external device (display device, analysis device, and the like).

### Storage Unit 290

The storage unit 290 includes, for example, a semiconductor storage device or the like, and can store control executed by the signal processing unit 230, various data, various data acquired from the external device, and the like.

### 2.3 Distance Measurement Method

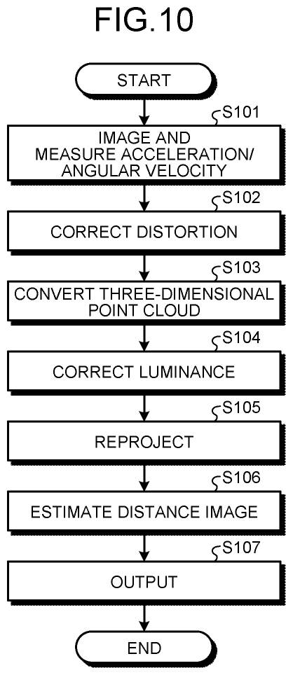

Next, an example of a distance measuring method according to the present embodiment will be described with reference to FIG. 10. FIG. 10 is a flowchart illustrating an example of a distance measuring method according to the present embodiment.

As illustrated in FIG. 10, the distance measuring method according to the present embodiment can mainly include steps from step S101 to step S107. Details of these steps according to the present embodiment will be described below.

The distance measuring device 10 images the object (target object) 3 at the phase of 0 degrees, the phase of 90 degrees, the phase of 180 degrees, and the phase of 270 degrees (1 frame), and measures acceleration and angular velocity at the time of each imaging (step S101). Moreover, the distance measuring device 10 sets one of a plurality of pieces of pixel data (luminance image) acquired within one frame as reference data (reference luminance image), and acquires information of a relative position and a relative attitude of the imaging unit 210 when a plurality of pieces of other pixel data is acquired with respect to the position and attitude (reference position) of the imaging unit 210 when the reference data is acquired. Furthermore, the distance measuring device 10 acquires information of the relative position and the relative attitude of the reference position of the target frame with respect to the reference position of the previous frame of the target frame.

The distance measuring device 10 corrects distortion due to an optical system such as a lens in the pixel data (luminance image) (step S102).

The distance measuring device 10 corrects a plurality of pieces of other pixel data other than the reference data on the basis of the relative position and the relative attitude of the imaging unit 210 when a plurality of pieces of other pixel data (luminance images) in the same target frame is acquired with respect to the position and the attitude (reference position) of the imaging unit 210 when the reference data of the target frame is acquired. Moreover, the distance measuring device 10 corrects all the pixel data of the target frame with reference to the depth map (distance image) of the previous frame on the basis of the relative position and the relative attitude of the reference position of the target frame with respect to the reference position of the previous frame of the target frame. That is, the distance measuring device 10 converts the coordinate information (three-dimensional point cloud) of all the pixel data of the target frame on the basis of the relative position and the relative attitude (step S103).

The distance measuring device 10 corrects the luminance value (luminance information) associated with each coordinate on the basis of the distance (displacement) between the imaging unit (light receiving unit) 210 and the object (target object) 3 changed in step S103 (step S104). Note that, in the present embodiment, the execution of step S104 may be omitted.

The distance measuring device 10 reprojects each piece of pixel data subjected to the luminance correction (step S105).

The distance measuring device 10 calculates the distance to the object (target object) 3 on the basis of the corrected pixel data (luminance image) and generates the depth map (distance image) (step S106).

The distance measuring device 10 outputs the depth map to the external device (display device, analysis device, and the like) (step S107).

As described above, in the present embodiment, the depth map (distance image) is generated by correcting all the pixel data (luminance images) so as to be luminance images from the viewpoint of the reference position, that is, from the same viewpoint on the basis of the relative position and the relative attitude of the imaging unit 210. Therefore, according to the present embodiment, it is possible to remove the influence of movement of the imaging unit 210 in the pixel data, suppress the occurrence of motion blur in the depth map (distance image) finally generated, and acquire a higher quality depth map (distance image).

### 3. Second Embodiment

### 3.1 2-Tap Sensor

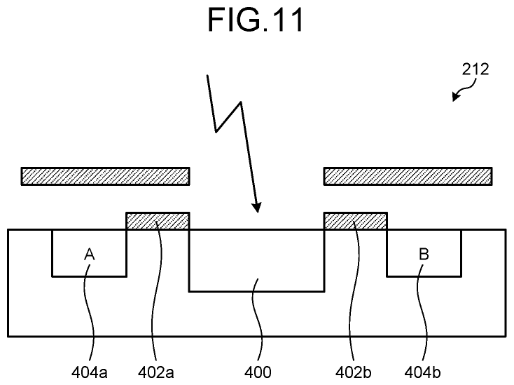

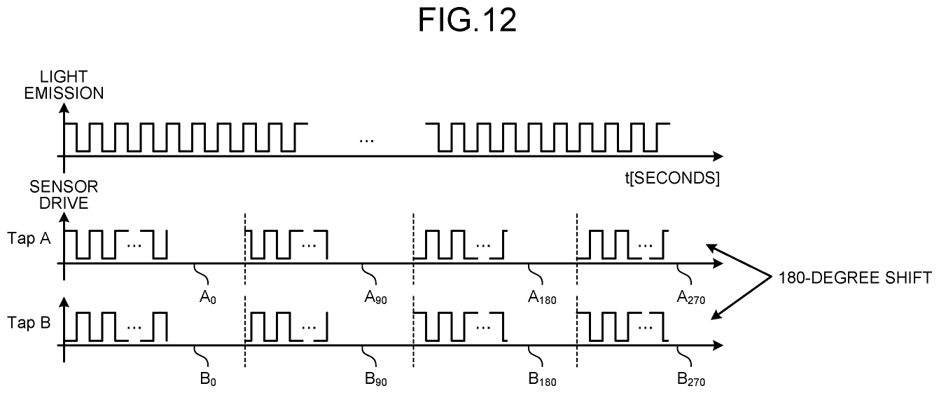

In a second embodiment of the present disclosure described below, the pixel array of the imaging unit 210 has 2-tap type pixels. Therefore, a 2-tap type pixel will be described with reference to FIGS. 11 and 12. FIG. 11 is a schematic diagram illustrating an example of the structure of a 2-tap type pixel 212, and FIG. 12 is an explanatory diagram for describing operation of the 2-tap type pixel 212 illustrated in FIG. 11.

As illustrated in FIG. 11, the pixel 212 has a 2-tap type structure, and specifically includes one photodiode (photoelectric conversion unit) 400 and two charge storage units 404a and 404b. In the pixel 212, the charge generated by the light incident on the photodiode 400 depending on the timing can be distributed to one of the two charge storage units 404a and 404b depending on the timing. The distribution can be controlled by voltages applied to gates (distribution units) 402a and 402b. For example, the pixel 212 can switch the distribution in several 10 nanoseconds, that is, can switch at high speed.

Then, by switching the pixel 212 having such a 2-tap type structure at high speed, as illustrated in FIG. 12, eight pieces of pixel data (luminance image) instead of four pieces of pixel data can be obtained in one frame. Specifically, as illustrated in the lower part of FIG. 12, the pixel 212 is operated at a high speed so as to be alternately distributed to the charge storage units 404a and 404b at different timings. By operating in this manner, the pixel 212 can simultaneously acquire two pieces of pixel data having phases inverted with respect to each other (that is, the phase difference is 180 degrees).

Therefore, as illustrated in FIG. 12, by using the 2-tap type pixel 212, the imaging unit 210 can acquire pixel data A₀, A₉₀, A₁₈₀, and A₂₇₀ of 0 degrees, 90 degrees, 180 degrees, and 270 degrees in one frame on the basis of the charges accumulated in the charge storage unit 404a. Furthermore, the imaging unit 210 can acquire pixel data B₀, B₉₀, B₁₈₀, and B₂₇₀ of 0 degrees, 90 degrees, 180 degrees, and 270 degrees in one frame on the basis of the charge accumulated in the charge storage unit 404b. That is, the imaging unit 210 can obtain eight pieces of pixel data (luminance images) in one frame.

Note that, in the present embodiment, the pixel 212 is not limited to a structure including one photodiode 400 and two charge storage units 404a and 404b. For example, the pixel 212 may have a structure including two photodiodes having substantially the same (mostly the same) characteristics as each other by being simultaneously manufactured, and one charge storage unit. In this case, the two diodes operate (differential) at different timings.

### 3.2 Outline of Embodiment

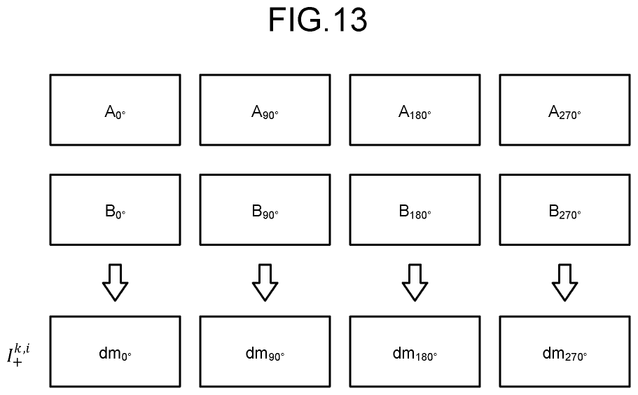

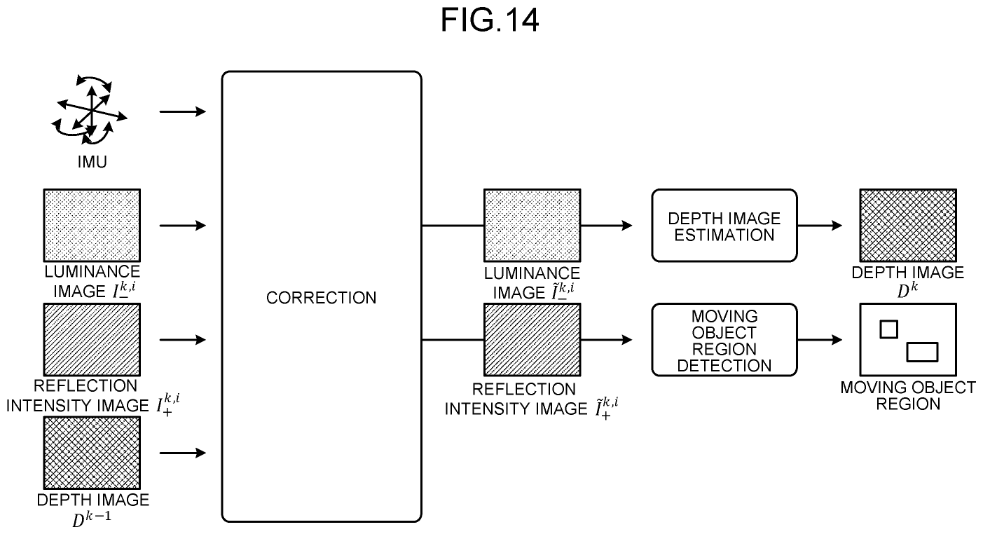

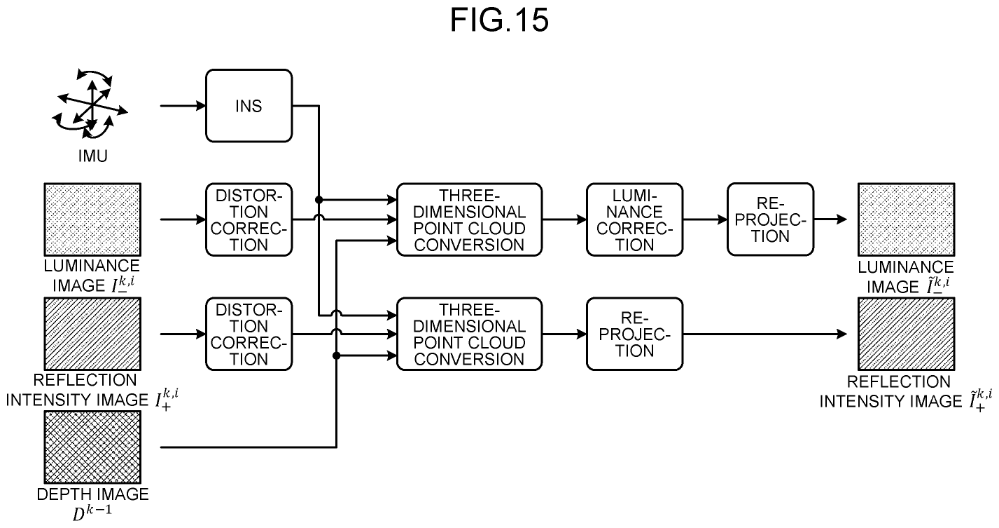

In the second embodiment of the present disclosure described below, as described above, the imaging unit 210 having the pixel array including the above-described 2-tap type pixels is used. In the present embodiment, since two pieces of pixel data having phases inverted with respect to each other (that is, the phase difference is 180 degrees) can be simultaneously acquired by using the 2-tap type, a pure reflection intensity image can be generated by adding these two pieces of pixel data. Hereinafter, details of the reflection intensity image will be described with reference to FIG. 13. FIG. 13 is an explanatory diagram for describing the present embodiment.

As illustrated in FIG. 13, in the present embodiment, eight pieces of pixel data A₀, A₉₀, A₁₈₀, A₂₇₀, B₀, B₉₀, B₁₈₀, and B₂₇₀ of 0 degrees, 90 degrees, 180 degrees, and 270 degrees can be acquired in one frame. Moreover, the phases of the pieces of image data having the same phase are inverted from each other (that is, the phase difference is 180 degrees). Therefore, in the present embodiment, four reflection intensity images I₊^{k, i}, dm₀, dm₉₀, dm₁₈₀, and dm₂₇₀ illustrated in the lower part of FIG. 13 can be obtained by adding the same phases as illustrated in the following Expression (7).

dm₀=(A₀−B₀)

dm₉₀=(A₉₀−B₉₀)

dm₁₈₀=(A₁₈₀−B₁₈₀)

dm₂₇₀=(A₂₇₆−B₂₇₀) (7)

In the present embodiment, by performing such addition, a fixed noise pattern generated in the pixel array and noise of the ambient light are canceled out, and moreover, the luminance value is doubled, and the reflection intensity image, which is clearer pixel data, can be obtained. Then, in the present embodiment, correction similar to that in the first embodiment is performed on such a reflection intensity image, and the reflection intensity image from the same viewpoint is generated. Moreover, in the present embodiment, by taking a difference between a plurality of reflection intensity images by using the fact that the luminance value does not change between different phases in the reflection intensity images, it is possible to detect a moving object that is an object in motion (target object) 3. Therefore, the distance measuring device 10 according to the present embodiment can perform the moving object detection as described above at the same time as performing the distance measurement of the first embodiment.

Moreover, an outline of a second embodiment of the present disclosure will be described with reference to FIGS. 14 and 15. FIGS. 14 and 15 are explanatory diagrams for describing the present embodiment.

As illustrated in FIG. 14, also in the present embodiment, the luminance image I₋^{k, i} is corrected using the sensing data from the IMU and the depth map (depth image) D^{k-1} one frame before, depth image estimation is performed using the luminance images I^{˜}₋^{k, i} after correction, and the depth image (depth map) D^{k} is acquired. That is, also in the present embodiment, the occurrence of motion blur can be suppressed by correcting the luminance image I₋^{k, i}.

In addition, in the present embodiment, as in the first embodiment, the reflection intensity image I₊^{k, i} is corrected using the sensing data from the IMU and the depth map (depth image) D^{k-1} one frame before, and a moving object region in the image can be detected using the reflection intensity image I₊^{k, i} after correction. By the above correction, the influence of movement of the imaging unit 210 in the reflection intensity image I₊^{k, i} can be removed, so that a moving object in the image can be detected. For example, by using such moving object detection, it is possible to specify a region in the image in which distance measurement cannot be accurately performed due to movement of the object (target object) 3, and thereby it is possible to perform distance measurement or generate a three-dimensional model by selectively using a region of the depth map (depth image) other than the specified region.

More specifically, also in the present embodiment, as illustrated in FIG. 15, the relative position and the relative attitude of the imaging unit (light receiving unit) 210 can be obtained on the basis of the INS using the angular velocity and the acceleration that are the sensing data from the IMU mounted on the distance measuring device 10. Moreover, in the present embodiment, the reflection intensity images I^{˜}₊^{k, i} after correction can be obtained by performing correction and reprojecting by converting the three-dimensional point cloud included in each of the curvature-corrected reflection intensity images I₊^{k, i} using the relative position and the relative attitude of the imaging unit (light receiving unit) 210 obtained in this manner and the depth map (depth image) D^{k-1} one frame before.

Hereinafter, details of the present embodiment will be described, but here, description will be given focusing on moving object detection.

### 3.3 Detailed Configuration of Signal Processing Unit 230a

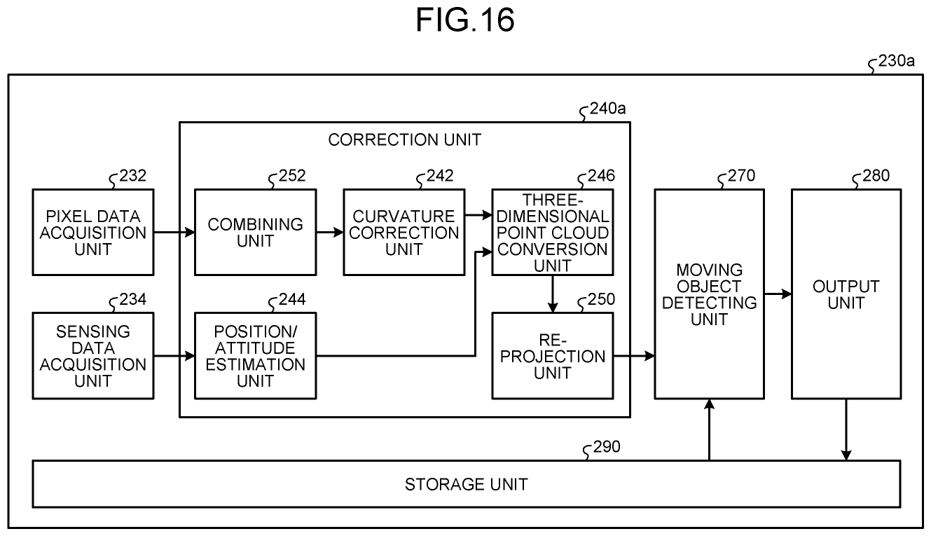

Next, a detailed configuration of the signal processing unit 230a according to the present embodiment will be described with reference to FIG. 16. FIG. 16 is a block diagram illustrating an example of a configuration of the signal processing unit 230a according to the present embodiment. As illustrated in FIG. 16, the signal processing unit 230a mainly includes the pixel data acquisition unit (first acquisition unit) 232, the sensing data acquisition unit (second acquisition unit) 234, a correction unit 240a, a moving object detecting unit (detecting unit) 270, the output unit 280, and the storage unit 290. Hereinafter, each functional block of the signal processing unit 230a will be sequentially described, but in the following description, description of functional blocks common to the signal processing unit 230 according to the first embodiment will be omitted.

Correction unit 240a

As in the first embodiment, the correction unit 240a can correct the pixel data (luminance image) from the imaging unit (light receiving unit) 210 on the basis of the position and the attitude of the imaging unit (light receiving unit) 210 obtained from the sensing data from the sensor unit (motion sensor) 300. Specifically, as illustrated in FIG. 16, the correction unit 240 mainly includes the curvature correction unit (distortion correction unit) 242, the position/attitude estimation unit (estimation unit) 244, the three-dimensional point cloud conversion unit (conversion unit) 246, and a combining unit 252. Note that, since the functional blocks other than the combining unit 252 are similar to those of the first embodiment, the description of these functional blocks will be omitted here, and only the description of the combining unit 252 will be given below.

The combining unit 252 can combine (add) the pixel data (luminance images) A₀, A₉₀, A₁₈₀, A₂₇₀, B₀, B₉₀, B₁₈₀, and B₂₇₀ having phases inverted with respect to each other (that is, the phase difference is 180 degrees) acquired in one frame. Then, the combining unit 252 can output the combined pixel data to the curvature correction unit 242.

### Moving Object Detecting Unit 270

The moving object detecting unit 270 can detect a moving object on the basis of the pixel data (luminance image) corrected by the correction unit 240a. Specifically, the moving object detecting unit 270 can specify the region of the moving object image on the basis of the difference between the combined pixel data. Note that, in the present embodiment, detection may be performed on the basis of a difference in luminance, or detection may be performed by a model obtained by machine learning, and a detection method is not limited.

### 3.4 Distance Measurement Method

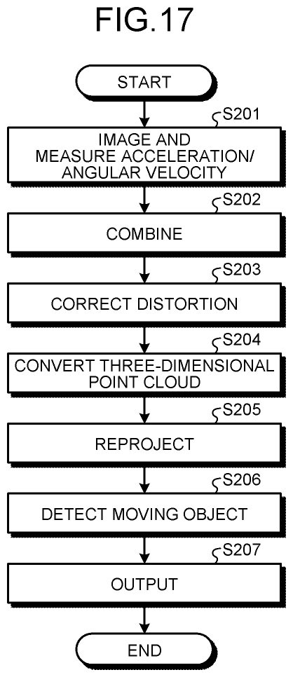

Next, an example of a distance measuring method according to the present embodiment will be described with reference to FIG. 17. FIG. 17 is a flowchart illustrating an example of a distance measuring method according to the present embodiment.

As illustrated in FIG. 17, the distance measuring method according to the present embodiment can mainly include steps from step S201 to step S207. Details of these steps according to the present embodiment will be described below.

As in the first embodiment, the distance measuring device 10 images the object (target object) 3 at the phase of 0 degrees, the phase of 90 degrees, the phase of 180 degrees, and the phase of 270 degrees (one frame), and measures acceleration and angular velocity at the time of each imaging (step S201). Furthermore, as in the first embodiment, the distance measuring device 10 acquires information of the relative position and the relative attitude of the imaging unit 210.

The distance measuring device 10 combines pixel data (luminance images) A₀, A₉₀, A₁₈₀, A₂₇₀, B₀, B₉₀, B₁₈₀, and B₂₇₀ having phases inverted with respect to each other (that is, the phase difference is 180 degrees) acquired in one frame (step S202).

The distance measuring device 10 corrects distortion due to an optical system such as a lens in pixel data (luminance image) of the combined image (step S203).

Since steps S204 and S205 are the same as steps S103 and S105 of the distance measuring method of the first embodiment illustrated in FIG. 10, the description thereof is omitted here.

The distance measuring device 10 detects a moving object on the basis of the pixel data (luminance image) corrected in steps S203 and S204 (step S206).

The distance measuring device 10 outputs a moving object detection result to the external device (display device, analysis device, and the like) (step S207).

As described above, according to the present embodiment, since the influence of movement of the imaging unit 210 in the reflection intensity image I₊^{k, i} can be removed by correction, a moving object in the image can be detected. Then, according to the present embodiment, by using the moving object detection, it is possible to specify a region in the image in which distance measurement cannot be accurately performed due to movement of the object (target object) 3, and thereby it is possible to accurately execute various applications by selectively using the region of the depth map (depth image) other than the specified region.

### 4. Summary

As described above, according to the embodiment of the present disclosure, the depth map (distance image) is generated by correcting all the pixel data (luminance images) so as to be luminance images from the viewpoint of the reference position, that is, from the same viewpoint on the basis of the relative position and the relative attitude of the imaging unit 210. Therefore, according to the present embodiment, it is possible to remove the influence of movement of the imaging unit 210 in the pixel data, suppress the occurrence of motion blur in the depth map (distance image) finally generated, and acquire a higher quality depth map (distance image).

Moreover, according to the present embodiment, since a high-quality depth map (distance image) can be acquired, quality improvement can be expected in various applications using such a distance measurement image.

For example, an example of the application may include simultaneous localization and mapping (SLAM). A SLAM recognition engine can create a map of the real space around the user and estimate the position and attitude of the user on the basis of the depth map around the user and the captured image. In order to accurately operate the SLAM recognition engine, it is conceivable to use the high-quality depth map according to the first embodiment. Moreover, in SLAM, when a surrounding object moves, it is not possible to accurately create a map or accurately estimate a relative position. Thus, by performing the moving object detection according to the second embodiment, the region in the image in which distance measurement cannot be accurately performed is specified, and the region of the depth map other than the specified region is selectively used, so that the improvement of SLAM estimation accuracy can be expected.

Further, for example, it is conceivable to use the high-quality depth map according to the first embodiment as information indicating the structure of a real space even when a virtual object is superimposed on the real space as augmented reality and displayed in accordance with the structure of the real space.

Moreover, the high-quality depth map according to the first embodiment and the moving object detection according to the second embodiment can also be applied to generation of an occupancy grid map or the like in which information indicating the presence of an obstacle is mapped on virtual coordinates around a robot as surrounding information when a mobile body such as a robot is autonomously controlled.

Moreover, in generating a three-dimensional model of an object (three-dimensional modeling), generally, a three-dimensional point cloud (distance image) viewed from different viewpoints is accumulated in time series to estimate one highly accurate three-dimensional model. Δt this time, the accuracy of the three-dimensional model can be expected to be improved by using the distance image in which the moving object region is removed by applying the moving object detection according to the second embodiment.

### 5. Hardware Configuration

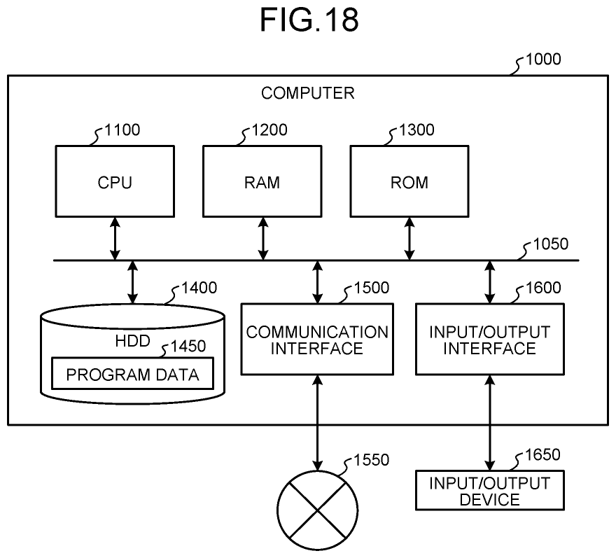

The signal processing unit 230 according to each embodiment described above may be implemented by, for example, a computer 1000 having a configuration as illustrated in FIG. 18 connected to the distance measuring device 10 via a network. FIG. 18 is a hardware configuration diagram illustrating an example of a computer that implements functions of the signal processing unit 230. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by such a program, and the like. Specifically, the HDD 1400 is a recording medium that records a distance measuring program according to the present disclosure as an example of program data 1450.

The communication interface 1500 is an interface for the computer 1000 to connect to an external network 1550 (for example, the Internet). For example, the CPU 1100 receives data from another device or transmits data generated by the CPU 1100 to the distance measuring device 10 via the communication interface 1500.

The input/output interface 1600 is an interface for connecting an input/output device 1650 and the computer 1000. For example, the CPU 1100 receives data from an input device such as a keyboard and a mouse via the input/output interface 1600. Further, the CPU 1100 transmits data to an output device such as a display, a speaker, or a printer via the input/output interface 1600. Furthermore, the input/output interface 1600 may function as a media interface that reads a program or the like recorded in a predetermined recording medium. The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the signal processing unit 230 according to the embodiment of the present disclosure, the CPU 1100 of the computer 1000 implements the functions of the correction unit 240 and the like by executing the distance measuring program loaded on the RAM 1200. Further, the HDD 1400 stores the distance measuring program and the like according to the embodiment of the present disclosure.

Note that the CPU 1100 reads the program data 1450 from the HDD 1400 and executes the program data 1450, but as another example, these programs may be acquired from another device via the external network 1550.

Furthermore, the signal processing unit 230 according to the present embodiment may be applied to a system including a plurality of devices on the premise of connection to a network (or communication between devices), such as cloud computing, for example.

### 6. Application Example

### 6.1 Application Example to Smartphone

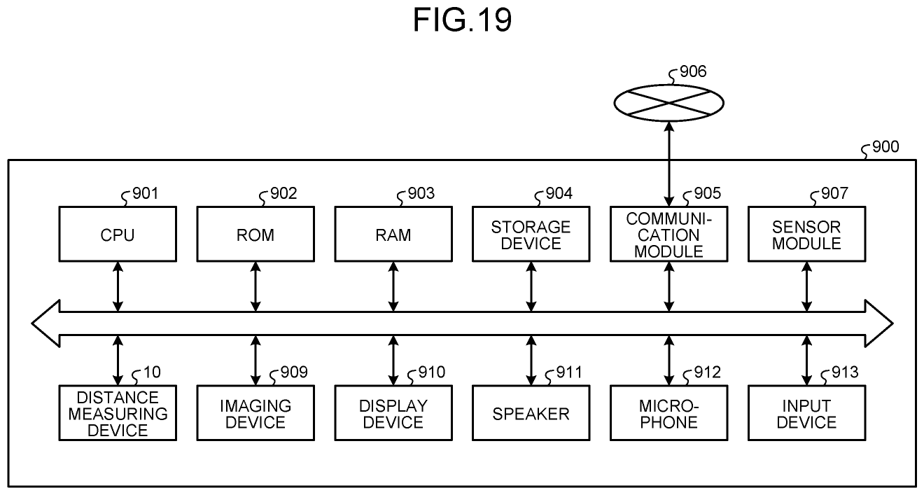

Note that the above-described distance measuring device 10 can be applied to various electronic devices such as a camera having a distance measuring function, a smartphone having a distance measuring function, and an industrial camera provided in a production line, for example. Thus, a configuration example of a smartphone 900 as an electronic device to which the present technology is applied will be described with reference to FIG. 19. FIG. 19 is a block diagram illustrating a configuration example of the smartphone 900 as an electronic device to which the distance measuring device 10 according to the embodiment of the present disclosure is applied.

As illustrated in FIG. 19, the smartphone 900 includes a central processing unit (CPU) 901, a read only memory (ROM) 902, and a random access memory (RAM) 903. Further, the smartphone 900 includes a storage device 904, a communication module 905, and a sensor module 907. Moreover, the smartphone 900 includes the above-described distance measuring device 10, and further includes an imaging device 909, a display device 910, a speaker 911, a microphone 912, an input device 913, and a bus 914. In addition, the smartphone 900 may include a processing circuit such as a digital signal processor (DSP) instead of or in addition to the CPU 901.

The CPU 901 functions as an arithmetic processing device and a control device, and controls the overall operation in the smartphone 900 or a part thereof according to various programs recorded in the ROM 902, the RAM 903, the storage device 904, or the like. The ROM 902 stores programs, operation parameters, and the like used by the CPU 901. The RAM 903 primarily stores programs used in the execution of the CPU 901, parameters that appropriately change in the execution, and the like. The CPU 901, the ROM 902, and the RAM 903 are connected to one another by a bus 914. In addition, the storage device 904 is a device for data storage configured as an example of a storage unit of the smartphone 900. The storage device 904 includes, for example, a magnetic storage device such as a hard disk drive (HDD), a semiconductor storage device, an optical storage device, and the like. The storage device 904 stores programs and various data executed by the CPU 901, various data acquired from the outside, and the like.

The communication module 905 is a communication interface including, for example, a communication device for connecting to a communication network 906. The communication module 905 can be, for example, a communication card for wired or wireless local area network (LAN), Bluetooth (registered trademark), wireless USB (WUSB), or the like. Furthermore, the communication module 905 may be a router for optical communication, a router for asymmetric digital subscriber line (ADSL), a modem for various types of communication, or the like. The communication module 905 transmits and receives, for example, signals and the like to and from the Internet and other communication devices using a predetermined protocol such as TCP/IP. Furthermore, the communication network 906 connected to the communication module 905 is a network connected in a wired or wireless manner, and is, for example, the Internet, a home LAN, infrared communication, satellite communication, or the like.

The sensor module 907 includes, for example, various sensors such as a motion sensor (for example, an acceleration sensor, a gyro sensor, a geomagnetic sensor, or the like), a biological information sensor (for example, a pulse sensor, a blood pressure sensor, a fingerprint sensor, and the like), or a position sensor (for example, a global navigation satellite system (GNSS) receiver or the like).

The distance measuring device 10 is provided on the surface of the smartphone 900, and can acquire, for example, a distance to a subject or a three-dimensional shape facing the surface as a distance measurement result.

The imaging device 909 is provided on the surface of the smartphone 900, and can image a target object 800 or the like located around the smartphone 900. Specifically, the imaging device 909 can include an imaging element (not illustrated) such as a complementary MOS (CMOS) image sensor, and a signal processing circuit (not illustrated) that performs imaging signal processing on a signal photoelectrically converted by the imaging element. Moreover, the imaging device 909 can further include an optical system mechanism (not illustrated) including an imaging lens, a diaphragm mechanism, a zoom lens, a focus lens, and the like, and a drive system mechanism (not illustrated) that controls the operation of the optical system mechanism. Then, the imaging element collects incident light from a subject as an optical image, and the signal processing circuit can acquire a captured image by photoelectrically converting the formed optical image in units of pixels, reading a signal of each pixel as an imaging signal, and performing image processing.

The display device 910 is provided on the surface of the smartphone 900, and can be, for example, a display device such as a liquid crystal display (LCD) or an organic electro luminescence (EL) display. The display device 910 can display an operation screen, a captured image acquired by the above-described imaging device 909, and the like.

The speaker 911 can output, for example, a call voice, a voice accompanying the video content displayed by the display device 910 described above, and the like to the user.

The microphone 912 can collect, for example, a call voice of the user, a voice including a command to activate a function of the smartphone 900, and a voice in a surrounding environment of the smartphone 900.

The input device 913 is a device operated by the user, such as a button, a keyboard, a touch panel, or a mouse. The input device 913 includes an input control circuit that generates an input signal on the basis of information input by the user and outputs the input signal to the CPU 901. By operating the input device 913, the user can input various data to the smartphone 900 and give an instruction on a processing operation.

The configuration example of the smartphone 900 has been described above. Each of the above-described components may be configured using a general-purpose member, or may be configured by hardware specialized for the function of each component. Such a configuration can be appropriately changed depending on the technical level at the time of implementation.

### 6.2 Application Example to Mobile Body

The technology according to the present disclosure (present technology) can be applied to various products. For example, the technology according to the present disclosure may be implemented as a device mounted on any type of mobile body such as an automobile, an electric vehicle, a hybrid electric vehicle, a motorcycle, a bicycle, a personal mobility, an airplane, a drone, a boat, a robot, and the like.

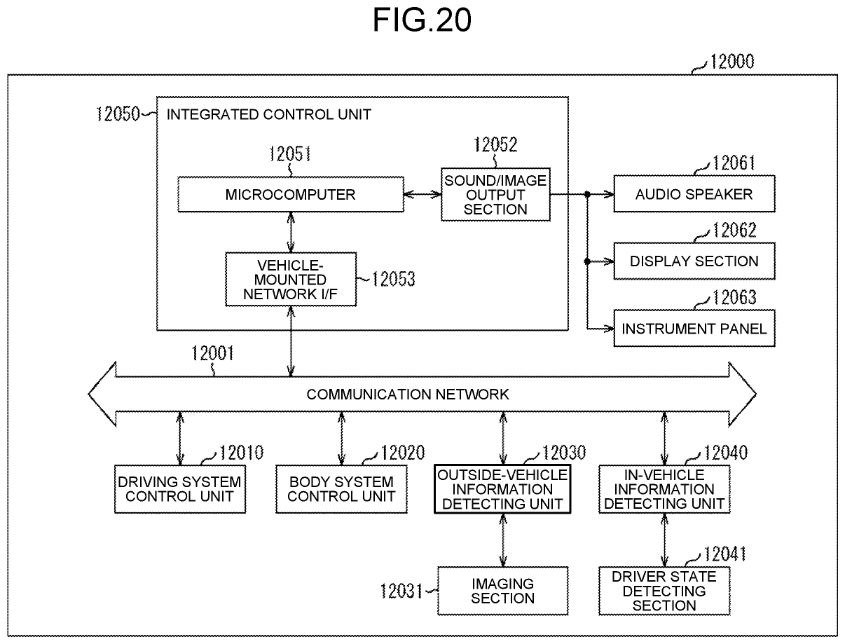

FIG. 20 is a block diagram depicting an example of schematic configuration of a vehicle control system as an example of a mobile body control system to which the technology according to an embodiment of the present disclosure can be applied.

A vehicle control system 12000 includes a plurality of electronic control units connected to each other via a communication network 12001. In the example depicted in FIG. 20, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs.

For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 20, an audio speaker 12061, a display section 12062, and an instrument panel 12063 are illustrated as the output device. The display section 12062 may, for example, include at least one of an on-board display and a head-up display.

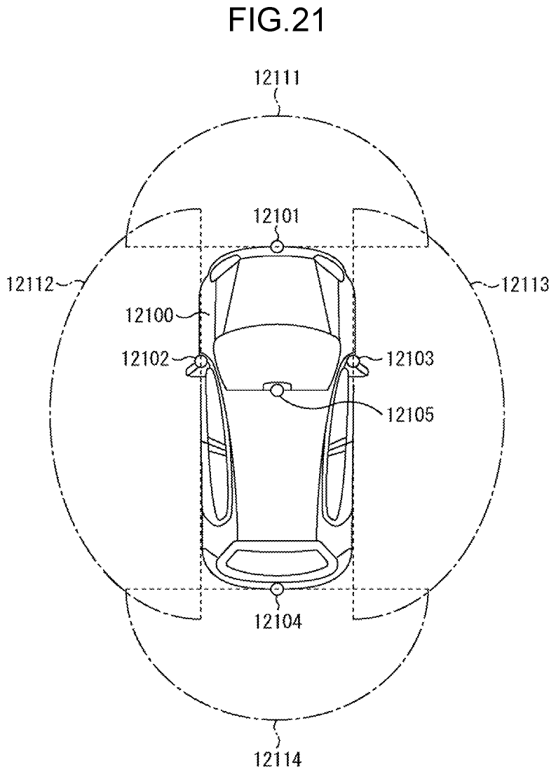

FIG. 21 is a diagram depicting an example of the installation position of the imaging section 12031.

In FIG. 21, a vehicle 12100 includes imaging sections 12101, 12102, 12103, 12104, and 12105 as the imaging section 12031.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The front images acquired by the imaging sections 12101 and 12105 are mainly used for detecting a preceding vehicle, a pedestrian, an obstacle, a traffic light, a traffic sign, a lane, or the like.

Incidentally, FIG. 21 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

Δt least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

Δt least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the outside-vehicle information detecting unit 12030 and the in-vehicle information detecting unit 12040 among the above-described configurations. Specifically, by using distance measurement by the distance measuring device 10 as the outside-vehicle information detecting unit 12030 and the in-vehicle information detecting unit 12040, it is possible to perform processing of recognizing a gesture of the driver, execute various operations (for example, an audio system, a navigation system, and an air conditioning system) according to the gesture, and more accurately detect the state of the driver. Furthermore, the unevenness of the road surface can be recognized using the distance measurement by the distance measuring device 10 and reflected in the control of the suspension.

### 7. Supplement

Although the preferred embodiments of the present disclosure have been described in detail with reference to the accompanying drawings, the technical scope of the present disclosure is not limited to such examples. It is obvious that a person having ordinary knowledge in the technical field of the present disclosure can conceive various changes or modification examples within the scope of the technical idea described in the claims, and it is naturally understood that these also belong to the technical scope of the present disclosure.

Furthermore, the effects described in the present description are merely illustrative or exemplary, and are not restrictive. That is, the technology according to the present disclosure can exhibit other effects obvious to those skilled in the art from the description of the present description together with or instead of the above effects.

Furthermore, for example, a configuration described as one device may be divided and configured as a plurality of devices. Conversely, the configurations described above as a plurality of devices may be collectively configured as one device. Furthermore, it is a matter of course that a configuration other than those described above may be added to the configuration of each device. Moreover, as long as the configuration and operation of the entire system are substantially the same, a part of the configuration of a certain device may be included in the configuration of another device. Note that, the above system means a set of a plurality of components (devices, modules (parts), and the like), and it does not matter whether or not all the components are in the same housing. Therefore, a plurality of devices housed in separate housings and connected via a network and one device in which a plurality of modules is housed in one housing are both comprehended as systems.

Note that the present technology can also have the following configurations.
(1) A distance measuring device, comprising:
   a first acquisition unit that acquires a plurality of luminance images from a light receiving unit that receives light having a predetermined irradiation pattern reflected by a target object while sequentially shifting the light by a predetermined phase with reference to the irradiation pattern;
   a second acquisition unit that acquires sensing data from a motion sensor that detects a position and an attitude of the light receiving unit;
   a correction unit that corrects the luminance images on a basis of the position and the attitude obtained from the sensing data; and
   a calculation unit that calculates a distance to the target object on a basis of the plurality of corrected luminance images.
(2) The distance measuring device according to (1), wherein
   the correction unit
   sets one of the plurality of luminance images acquired within one frame as a reference luminance image, and
   corrects the plurality of other luminance images on a basis of a relative position and a relative attitude of the light receiving unit when a plurality of other luminance images is acquired with respect to a position and an attitude of the light receiving unit when the reference luminance image is acquired.
(3) The distance measuring device according to (2), wherein the correction unit includes an estimation unit that estimates a relative position and a relative attitude of the light receiving unit when each of the other luminance images is obtained from the sensing data in time series of the motion sensor.
(4) The distance measuring device according to any one of (1) to (3), further comprising a control unit that controls an irradiation unit that irradiates the target object with the light.
(5) The distance measuring device according to (4), further comprising:
   the irradiation unit;
   the light receiving unit; and
   a motion sensor that detects a position and an attitude of the light receiving unit.
(6) The distance measuring device according to (5), wherein
   the light receiving unit includes a plurality of pixels arranged in a matrix on a plane.
(7) The distance measuring device according to (6), wherein the luminance image includes luminance information of reflected light received by each of the pixels and coordinate information of each of the pixels.
(8) The distance measuring device according to (7), wherein the correction unit includes a conversion unit that converts the coordinate information on a basis of the position and the attitude.
(9) The distance measuring device according to (8), wherein the correction unit includes a luminance correction unit that corrects the luminance information on a basis of a displacement of a distance between the light receiving unit and the target object due to the conversion.
(10) The distance measuring device according to any one of (6) to (9), wherein the correction unit includes a distortion correction unit that corrects distortion of the luminance image due to an optical system.
(11) The distance measuring device according to any one of (6) to (10), wherein the motion sensor includes an accelerometer and an angular velocity meter mounted on the light receiving unit.
(12) The distance measuring device according to any one of (6) to (11), wherein the calculation unit generates a depth map on a basis of the plurality of corrected luminance images.
(13) The distance measuring device according to any one of (6) to (12), wherein
   each of the pixels includes
   one photoelectric conversion unit that receives light and photoelectrically converts the light to generate a charge;
   two charge storage units that store the charge; and
   a distribution unit that distributes the charge to each of the charge storage units at different timings.

(14) The distance measuring device according to (13), wherein the correction unit includes a combining unit that combines the two luminance images based on the charge accumulated in each of the charge storage units.
(15) The distance measuring device according to (14), wherein a phase difference between the two luminance images is 180 degrees.
(16) The distance measuring device according to (14) or (15), further comprising a detecting unit that detects a moving object on a basis of the plurality of corrected luminance images.
(17) The distance measuring device according to (16), wherein the detecting unit specifies an image region of the moving object on a basis of a difference between the plurality of corrected luminance images.
(18) A distance measuring system, comprising:
   an irradiation unit that irradiates a target object with light having a predetermined irradiation pattern;
   a light receiving unit that receives the light reflected by the target object while sequentially shifting the light by a predetermined phase with reference to the irradiation pattern;
   a motion sensor that detects a position and an attitude of the light receiving unit;
   a control unit that controls the irradiation unit;
   a correction unit that acquires a plurality of luminance images from the light receiving unit, acquires sensing data from the motion sensor, and corrects the luminance images on a basis of the position and the attitude obtained from the sensing data; and
   a calculation unit that calculates a distance to the target object on a basis of the plurality of corrected luminance images.
(19) A distance measuring method comprising,
   by a processor:
   acquiring a plurality of luminance images from a light receiving unit that receives light having a predetermined irradiation pattern reflected by a target object while sequentially shifting the light by a predetermined phase with reference to the irradiation pattern;
   acquiring sensing data from a motion sensor that detects a position and an attitude of the light receiving unit;
   correcting the luminance images on a basis of the position and the attitude obtained from the sensing data; and
   calculating a distance to the target object on a basis of the plurality of corrected luminance images.

### REFERENCE SIGNS LIST

1 LIGHT EMITTING SOURCE
2 DISTANCE MEASURING SENSOR
3 OBJECT
10 DISTANCE MEASURING DEVICE
100 LIGHT SOURCE UNIT
200 DISTANCE MEASURING UNIT
210 IMAGING UNIT
212 PIXEL
220 LIGHT EMISSION CONTROL UNIT
230, 230a SIGNAL PROCESSING UNIT
232 PIXEL DATA ACQUISITION UNIT
234 SENSING DATA ACQUISITION UNIT
240, 240a CORRECTION UNIT
242 CURVATURE CORRECTION UNIT
244 POSITION/ATTITUDE ESTIMATION UNIT
246 THREE-DIMENSIONAL POINT CLOUD CONVERSION UNIT
248 LUMINANCE CORRECTION UNIT
250 REPROJECTION UNIT
252 COMBINING UNIT
260 DISTANCE IMAGE ESTIMATION UNIT
270 MOVING OBJECT DETECTING UNIT
280 OUTPUT UNIT
290 STORAGE UNIT
300 SENSOR UNIT
302 GYRO SENSOR
304 ACCELERATION SENSOR
400 PHOTODIODE
402a, 402b GATE
404a, 404b CHARGE STORAGE UNIT

1. A distance measuring device, comprising:
a first acquisition unit that acquires a plurality of luminance images from a light receiving unit that receives light having a predetermined irradiation pattern reflected by a target object while sequentially shifting the light by a predetermined phase with reference to the irradiation pattern;
a second acquisition unit that acquires sensing data from a motion sensor that detects a position and an attitude of the light receiving unit;
a correction unit that corrects the luminance images on a basis of the position and the attitude obtained from the sensing data; and
a calculation unit that calculates a distance to the target object on a basis of the plurality of corrected luminance images.

2. The distance measuring device according to claim 1, wherein
the correction unit
sets one of the plurality of luminance images acquired within one frame as a reference luminance image, and
corrects the plurality of other luminance images on a basis of a relative position and a relative attitude of the light receiving unit when a plurality of other luminance images is acquired with respect to a position and an attitude of the light receiving unit when the reference luminance image is acquired.

3. The distance measuring device according to claim 2, wherein the correction unit includes an estimation unit that estimates a relative position and a relative attitude of the light receiving unit when each of the other luminance images is obtained from the sensing data in time series of the motion sensor.

4. The distance measuring device according to claim 1, further comprising a control unit that controls an irradiation unit that irradiates the target object with the light.

5. The distance measuring device according to claim 4, further comprising:
the irradiation unit;
the light receiving unit; and
a motion sensor that detects a position and an attitude of the light receiving unit.

6. The distance measuring device according to claim 5, wherein
the light receiving unit includes a plurality of pixels arranged in a matrix on a plane.

7. The distance measuring device according to claim 6, wherein the luminance image includes luminance information of reflected light received by each of the pixels and coordinate information of each of the pixels.

8. The distance measuring device according to claim 7, wherein the correction unit includes a conversion unit that converts the coordinate information on a basis of the position and the attitude.

9. The distance measuring device according to claim 8, wherein the correction unit includes a luminance correction unit that corrects the luminance information on a basis of a displacement of a distance between the light receiving unit and the target object due to the conversion.

10. The distance measuring device according to claim 6, wherein the correction unit includes a distortion correction unit that corrects distortion of the luminance image due to an optical system.

11. The distance measuring device according to claim 6, wherein the motion sensor includes an accelerometer and an angular velocity meter mounted on the light receiving unit.

12. The distance measuring device according to claim 6, wherein the calculation unit generates a depth map on a basis of the plurality of corrected luminance images.

13. The distance measuring device according to claim 6, wherein
each of the pixels includes
one photoelectric conversion unit that receives light and photoelectrically converts the light to generate a charge;
two charge storage units that store the charge; and
a distribution unit that distributes the charge to each of the charge storage units at different timings.

14. The distance measuring device according to claim 13, wherein the correction unit includes a combining unit that combines the two luminance images based on the charge accumulated in each of the charge storage units.

15. The distance measuring device according to claim 14, wherein a phase difference between the two luminance images is 180 degrees.

16. The distance measuring device according to claim 14, further comprising a detecting unit that detects a moving object on a basis of the plurality of corrected luminance images.

17. The distance measuring device according to claim 16, wherein the detecting unit specifies an image region of the moving object on a basis of a difference between the plurality of corrected luminance images.

18. A distance measuring system, comprising:
an irradiation unit that irradiates a target object with light having a predetermined irradiation pattern;
a light receiving unit that receives the light reflected by the target object while sequentially shifting the light by a predetermined phase with reference to the irradiation pattern;
a motion sensor that detects a position and an attitude of the light receiving unit;
a control unit that controls the irradiation unit;
a correction unit that acquires a plurality of luminance images from the light receiving unit, acquires sensing data from the motion sensor, and corrects the luminance images on a basis of the position and the attitude obtained from the sensing data; and
a calculation unit that calculates a distance to the target object on a basis of the plurality of corrected luminance images.

19. A distance measuring method comprising,
by a processor:
acquiring a plurality of luminance images from a light receiving unit that receives light having a predetermined irradiation pattern reflected by a target object while sequentially shifting the light by a predetermined phase with reference to the irradiation pattern;
acquiring sensing data from a motion sensor that detects a position and an attitude of the light receiving unit;
correcting the luminance images on a basis of the position and the attitude obtained from the sensing data; and
calculating a distance to the target object on a basis of the plurality of corrected luminance images.
